(19) United States
(12) Patent Application Publication
(10) Pub. No.: US 2025/0055616 A1
(43) Pub. Date: Feb. 13, 2025

(54) UNIFIED TRANSMISSION CONFIGURATION INDICATION FOR MULTIPLE TRANSMISSION RECEPTION POINTS

(71) Applicant: QUALCOMM INCORPORATED, San Diego, CA (US)

(72) Inventors: Fang Yuan, Beijing (CN); Yan Zhou, San Diego, CA (US); Tao Luo, San Diego, CA (US)

(21) Appl. No.: 18/721,146

(22) PCT Filed: Feb. 11, 2022
(86) PCT No.: PCT/CN2022/075953

§ 371 Date: Jun. 17, 2024

(51) Int. Cl. H04L 5/00; H04W 72/23; H04W 76/15

(52) U.S. Cl. CPC H04L 5/0035; H04L 5/0023; H04W 72/23; H04W 76/15

(57) ABSTRACT

Methods, systems, and devices for wireless communications are described. In some examples, a user equipment (UE) may receive signaling identifying a configuration for the UE to communicate with a first transmission reception point (TRP) and a second transmission reception point. The UE may receive a single downlink control message that includes one or more transmission configuration indicators, the one or more transmission configuration indicators indicating a first transmission configuration indicator state for the first TRP and a second transmission configuration indicator state for the second transmission reception point. The UE may communicate with at least one of the first TRP or the second TRP according to the one or more transmission configuration indicators based on receiving the single downlink control message.

### CROSS REFERENCE

The present application is a 371 national stage filing of International PCT Application No. PCT/CN2022/075953 by Yuan et al. entitled “UNIFIED TRANSMISSION CONFIGURATION INDICATION FOR MULTIPLE TRANSMISSION RECEPTION POINTS,” filed Feb. 11, 2022, which is assigned to the assignee hereof, and which is expressly incorporated by reference in its entirety herein.

### FIELD OF TECHNOLOGY

The following relates to wireless communications, including unified transmission configuration indication for multiple transmission reception points.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support unified transmission configuration indication for multiple transmission reception points. Generally, the described techniques provide for a user equipment (UE) to receive transmission configuration indicator (TCI) state information for multiple transmission reception points (TRPs) in a single instance of control information. For instance, a UE may receive signaling identifying a configuration for the UE to communicate with a first TRP and a second TRP. The UE may receive downlink control information includes one or more TCIs, the one or more TCIs indicating a first TCI state for the first TRP and a second TCI state for the second TRP. The UE may communicate with at least one of the first TRP or the second TRP according to the one or more TCIs based on receiving the downlink control information.

A method for wireless communication at a user equipment (UE) is described. The method may include receiving signaling identifying a configuration for the UE to communicate with a first transmission reception point and a second transmission reception point, receiving downlink control information that includes one or more transmission configuration indicators, the one or more transmission configuration indicators indicating a first transmission configuration indicator state for the first transmission reception point and a second transmission configuration indicator state for the second transmission reception point, and communicating with at least one of the first transmission reception point or the second transmission reception point according to the one or more transmission configuration indicators based on receiving the downlink control information.

An apparatus for wireless communication at a UE is described. The apparatus may include a processor, memory coupled with the processor, and instructions stored in the memory. The instructions may be executable by the processor to cause the apparatus to receive signaling identifying a configuration for the UE to communicate with a first transmission reception point and a second transmission reception point, receive downlink control information that includes one or more transmission configuration indicators, the one or more transmission configuration indicators indicating a first transmission configuration indicator state for the first transmission reception point and a second transmission configuration indicator state for the second transmission reception point, and communicate with at least one of the first transmission reception point or the second transmission reception point according to the one or more transmission configuration indicators based on receiving the downlink control information.

Another apparatus for wireless communication at a UE is described. The apparatus may include means for receiving signaling identifying a configuration for the UE to communicate with a first transmission reception point and a second transmission reception point, means for receiving downlink control information that includes one or more transmission configuration indicators, the one or more transmission configuration indicators indicating a first transmission configuration indicator state for the first transmission reception point and a second transmission configuration indicator state for the second transmission reception point, and means for communicating with at least one of the first transmission reception point or the second transmission reception point according to the one or more transmission configuration indicators based on receiving the downlink control information.

A non-transitory computer-readable medium storing code for wireless communication at a UE is described. The code may include instructions executable by a processor to receive signaling identifying a configuration for the UE to communicate with a first transmission reception point and a second transmission reception point, receive downlink control information that includes one or more transmission configuration indicators, the one or more transmission configuration indicators indicating a first transmission configuration indicator state for the first transmission reception point and a second transmission configuration indicator state for the second transmission reception point, and communicate with at least one of the first transmission reception point or the second transmission reception point according to the one or more transmission configuration indicators based on receiving the downlink control information.

In some examples of the method, apparatuses, and non-transitory computer-readable medium described herein, receiving the downlink control information that includes the one or more transmission configuration indicators may include operations, features, means, or instructions for receiving the downlink control information including a first codepoint in a first field of the downlink control information and a second codepoint in a second field of the downlink control information, where the first codepoint indicates the first transmission configuration indicator state and the second codepoint indicates the second transmission configuration indicator state.

In some examples of the method, apparatuses, and non-transitory computer-readable medium described herein, each of the first field and the second field indicates a respective joint transmission configuration indicator state, a downlink transmission configuration indicator state, an uplink transmission configuration indicator state, or any combination thereof.

In some examples of the method, apparatuses, and non-transitory computer-readable medium described herein, the communicating may include operations, features, means, or instructions for communicating with the other of the first transmission reception point or the second transmission reception point.

In some examples of the method, apparatuses, and non-transitory computer-readable medium described herein, receiving the downlink control information that includes the one or more transmission configuration indicators may include operations, features, means, or instructions for receiving the downlink control information including a codepoint in a field of the downlink control information, where the codepoint indicates the first transmission configuration indicator state and the second transmission configuration indicator state.

In some examples of the method, apparatuses, and non-transitory computer-readable medium described herein, the field indicates two joint transmission configuration indicator states, two downlink transmission configuration indicator states, two uplink configuration indicator states, or any combination thereof.

Some examples of the method, apparatuses, and non-transitory computer-readable medium described herein may further include operations, features, means, or instructions for receiving a first medium access control (MAC) control element (MAC-CE) transmission indicating to activate the first transmission configuration indicator state for the first transmission reception point, where communicating with the first transmission reception point may be based on receiving the first media access control (MAC)-CE transmission and receiving a second MAC-CE transmission indicating to activate the second transmission configuration indicator state for the second transmission reception point, where communicating with the second transmission reception point may be based on receiving the second MAC-CE transmission.

Some examples of the method, apparatuses, and non-transitory computer-readable medium described herein may further include operations, features, means, or instructions for receiving a medium access control (MAC) control element (MAC-CE) transmission indicating to activate the first transmission configuration indicator state for the first transmission reception point and the second transmission configuration indicator state for the second transmission reception point, where communicating with the first transmission reception point and the second transmission reception point may be based on receiving the MAC-CE transmission.

Some examples of the method, apparatuses, and non-transitory computer-readable medium described herein may further include operations, features, means, or instructions for receiving radio resource control signaling or medium access control (MAC) control element signaling indicating a respective set of channels, a respective set of reference signals, or both for each of the first transmission indicator state and the second transmission indicator state.

In some examples of the method, apparatuses, and non-transitory computer-readable medium described herein, the one or more transmission configuration indicators include a single transmission configuration indicator and the method, apparatuses, and non-transitory computer-readable medium may include further operations, features, means, or instructions for determining a first set of spatial parameters, a first spatial transmit filter, or both, for the first transmission reception point based on a first of the set of multiple reference signals and a second set of spatial parameters, a second spatial transmit filter, or both, for the second transmission reception point based on a second of the set of multiple reference signals.

Some examples of the method, apparatuses, and non-transitory computer-readable medium described herein may further include operations, features, means, or instructions for determining a first reference signal associated with the first transmission configuration indicator state based on a first transmission reception point identifier associated with the first reference signal and a second reference signal associated with the second transmission configuration indicator state based on a second transmission reception point identifier associated with the second reference signal.

In some examples of the method, apparatuses, and non-transitory computer-readable medium described herein, the first transmission reception point identifier and the second transmission reception point identifier each include a control resource set pool identifier, a sounding reference signal resource set identifier, a close-loop index identifier, or any combination thereof.

A method for wireless communication at a network is described. The method may include transmitting, to a UE, signaling identifying a configuration for the UE to communicate with a first transmission reception point and a second transmission reception point of the network, transmitting, to the UE, downlink control information that includes one or more transmission configuration indicators, the one or more transmission configuration indicators indicating a first transmission configuration indicator state for the first transmission reception point and a second first transmission configuration indicator state for the second transmission reception point, and communicating, from at least one of the first transmission reception point or the second transmission reception point, with the UE according to the one or more transmission configuration indicators based on transmitting the downlink control information.

An apparatus for wireless communication at a network is described. The apparatus may include a processor, memory coupled with the processor, and instructions stored in the memory. The instructions may be executable by the processor to cause the apparatus to transmit, to a UE, signaling identifying a configuration for the UE to communicate with a first transmission reception point and a second transmission reception point of the network, transmit, to the UE, downlink control information that includes one or more transmission configuration indicators, the one or more transmission configuration indicators indicating a first transmission configuration indicator state for the first transmission reception point and a second first transmission configuration indicator state for the second transmission reception point, and communicate, from at least one of the first transmission reception point or the second transmission reception point, with the UE according to the one or more transmission configuration indicators based on transmitting the downlink control information.

Another apparatus for wireless communication at a network is described. The apparatus may include means for transmitting, to a UE, signaling identifying a configuration for the UE to communicate with a first transmission reception point and a second transmission reception point of the network, means for transmitting, to the UE, downlink control information that includes one or more transmission configuration indicators, the one or more transmission configuration indicators indicating a first transmission configuration indicator state for the first transmission reception point and a second first transmission configuration indicator state for the second transmission reception point, and means for communicating, from at least one of the first transmission reception point or the second transmission reception point, with the UE according to the one or more transmission configuration indicators based on transmitting the downlink control information.

A non-transitory computer-readable medium storing code for wireless communication at a network is described. The code may include instructions executable by a processor to transmit, to a UE, signaling identifying a configuration for the UE to communicate with a first transmission reception point and a second transmission reception point of the network, transmit, to the UE, downlink control information that includes one or more transmission configuration indicators, the one or more transmission configuration indicators indicating a first transmission configuration indicator state for the first transmission reception point and a second first transmission configuration indicator state for the second transmission reception point, and communicate, from at least one of the first transmission reception point or the second transmission reception point, with the UE according to the one or more transmission configuration indicators based on transmitting the downlink control information.

In some examples of the method, apparatuses, and non-transitory computer-readable medium described herein, transmitting the downlink control information that includes the one or more transmission configuration indicators may include operations, features, means, or instructions for transmitting, to the UE, the downlink control information including a first codepoint in a first field of the downlink control information and a second codepoint in a second field of the downlink control information, where the first codepoint indicates the first transmission configuration indicator state and the second codepoint indicates the second transmission configuration indicator state.

In some examples of the method, apparatuses, and non-transitory computer-readable medium described herein, each of the first field and the second field indicates a respective joint transmission configuration indicator state, a downlink transmission configuration indicator state, an uplink configuration indicator state, or any combination thereof.

In some examples of the method, apparatuses, and non-transitory computer-readable medium described herein, the communicating may include operations, features, means, or instructions for communicating with the UE from the other of the first transmission reception point or the second transmission reception point.

In some examples of the method, apparatuses, and non-transitory computer-readable medium described herein, transmitting the downlink control information that includes the one or more transmission configuration indicators may include operations, features, means, or instructions for transmitting, to the UE, downlink control information including a codepoint in a field of the downlink control information, where the codepoint indicates the first transmission configuration indicator state and the second transmission configuration indicator state.

In some examples of the method, apparatuses, and non-transitory computer-readable medium described herein, the field indicates two joint transmission configuration indicator states, two downlink transmission configuration indicator states, two uplink configuration indicator states, or any combination thereof.

Some examples of the method, apparatuses, and non-transitory computer-readable medium described herein may further include operations, features, means, or instructions for transmitting a first medium access control (MAC) control element (MAC-CE) transmission indicating to activate the first transmission configuration indicator state for the first transmission reception point, where communicating from the first transmission reception point with the UE may be based on transmitting the first MAC-CE transmission and transmitting a second MAC-CE transmission indicating to activate the second transmission configuration indicator state for the second transmission reception point, where communicating from the second transmission reception point with the UE may be based on transmitting the second MAC-CE transmission.

Some examples of the method, apparatuses, and non-transitory computer-readable medium described herein may further include operations, features, means, or instructions for transmitting a medium access control (MAC) control element (MAC-CE) transmission indicating to activate the first transmission configuration indicator state for the first transmission reception point and the second transmission configuration indicator state for the second transmission reception point, where communicating from the first transmission reception point and the second transmission reception point with the UE may be based on transmitting the MAC-CE transmission.

Some examples of the method, apparatuses, and non-transitory computer-readable medium described herein may further include operations, features, means, or instructions for transmitting radio resource control signaling or medium access control (MAC) control element signaling indicating a respective set of channels, a respective set of reference signals, or both for each of the first transmission indicator state.

### BRIEF DESCRIPTION OF THE DRAWINGS

FIG. 1 illustrates an example of a wireless communications system that supports unified transmission configuration indication for multiple transmission reception points in accordance with aspects of the present disclosure.

FIG. 2 illustrates an example of a wireless communications system that supports unified transmission configuration indication for multiple transmission reception points in accordance with aspects of the present disclosure.

FIGS. 3A and 3B illustrate examples of transmission configuration indicator (TCI) indication schemes that support unified transmission configuration indication for multiple transmission reception points in accordance with aspects of the present disclosure.

FIG. 4 illustrates an example of a process flow that supports unified transmission configuration indication for multiple transmission reception points in accordance with aspects of the present disclosure.

FIGS. 5 and 6 show block diagrams of devices that support unified transmission configuration indication for multiple transmission reception points in accordance with aspects of the present disclosure.

FIG. 7 shows a block diagram of a communications manager that supports unified transmission configuration indication for multiple transmission reception points in accordance with aspects of the present disclosure.

FIG. 8 shows a diagram of a system including a device that supports unified transmission configuration indication for multiple transmission reception points in accordance with aspects of the present disclosure.

FIGS. 9 and 10 show block diagrams of devices that support unified transmission configuration indication for multiple transmission reception points in accordance with aspects of the present disclosure.

FIG. 11 shows a block diagram of a communications manager that supports unified transmission configuration indication for multiple transmission reception points in accordance with aspects of the present disclosure.

FIG. 12 shows a diagram of a system including a device that supports unified transmission configuration indication for multiple transmission reception points in accordance with aspects of the present disclosure.

FIGS. 13 through 16 show flowcharts illustrating methods that support unified transmission configuration indication for multiple transmission reception points in accordance with aspects of the present disclosure.

### DETAILED DESCRIPTION

A user equipment (UE) may communicate with a transmission reception point (TRP). In some examples, the UE may communicate with multiple TRPs in a multi-TRP (mTRP) mode. For instance, the UE may perform simultaneous communications with a first TRP and a second TRP. In some examples, communicating with a TRP may include the UE receiving downlink control information (DCI) that indicates a transmission configuration indicator (TCI) state for communication between the TRP and the UE. When communicating in an mTRP mode, transmitting multiple DCIs to convey multiple TCI states may increase a latency associated with communications between the UE and at least one of the TRPs. Techniques that decrease the latency associated with conveying multiple TCI states may increase the efficiency of communications.

The present disclosure describes techniques that may decrease the latency associated with conveying multiple TCI states. For instance, the present disclosure describes one DCI indicating TCI states for multiple TRPs. In a first example, a single DCI may include multiple TCI-indication fields, where each field may indicate a respective TCI state for a respective TRP (e.g., a first TCI indication field for a first TRP and a second TCI indication field for a second TRP). In a second example, a single DCI may be configured with one TCI field whose codepoint maps to multiple TCI states (e.g., a single TCI field that maps to a first TCI state for a first TRP and a second TCI state for a second TRP). In a third example, a single DCI may be configured with one TCI indication field that points to one TCI. However, the TCI may be associated with multiple reference signals, where each TRP may use a different one of the multiple reference signals. Accordingly, the UE may determine an associated TCI state for each TRP from a single DCI and the efficiency of wireless communications may increase.

Aspects of the disclosure are initially described in the context of wireless communications systems. Additional aspects of the disclosure are described in the context of a TCI indication scheme and a process flow. Aspects of the disclosure are further illustrated by and described with reference to apparatus diagrams, system diagrams, and flowcharts that relate to unified transmission configuration indication for multiple transmission reception points.

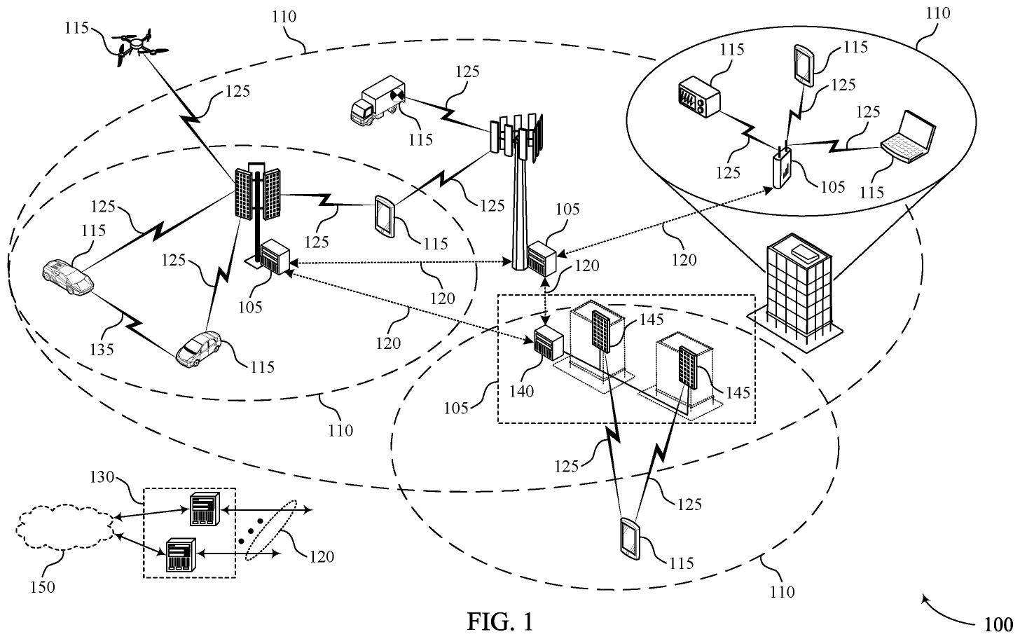

FIG. 1 illustrates an example of a wireless communications system 100 that supports unified transmission configuration indication for multiple transmission reception points in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC), central unit (CU), or distributed unit (DU). Each access network entity 140 may communicate with the UEs 115 through one or more other access network entities 140 or network transmission entities 145 (which may be referred to as radio units (RUs), radio heads, smart radio heads, remote radio heads (RRHs), or transmission/reception points (TRPs)). Each access network transmission entity 145 may include one or more antenna panels. In some configurations, various functions of each access network entity 140 or base station 105 may be distributed across various network devices (e.g., CUs, DUs, RUS, ANCs) or consolidated into a single network device (e.g., a base station 105). Communication between a base station 105 and a wireless device such as a UE 115 or another base station 105 may refer to communication between the device and any network entity 140 of the base station. For example, the phrases “transmitting,” “receiving,” or “communicating,” when referring to a network entity 140, may refer to any network entity 140 of a radio access network (RAN) communicating with another device or node (e.g., directly or via one or more other network entities 140 or network transmission entities 145).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Various types of unified TCI may be used for communications. For instance, a first type of unified TCI (e.g., Type 1 TCI) may be used to indicate a common beam for at least one downlink channel or reference signal and for at least one uplink channel or reference signal (e.g., a joint downlink uplink common TCI state). A second type of unified TCI (e.g., Type 2 TCI) may be used to indicate a common beam for more than one downlink channel or reference signal (e.g., a separate downlink common TCI state). A third type of unified TCI (e.g., Type 3 TCI) may be used to indicate a common beam for more than one uplink channel or reference signal (e.g. a separate uplink common TCI state). A fourth type of unified TCI (e.g., Type 4 TCI) may be used to indicate a beam for a single downlink channel or reference signal (e.g., a separate downlink single channel or reference signal TCI). A fifth type of unified TCI (e.g., Type 5 TCI) may be used to indicate a beam for a single uplink channel or reference signal (e.g., a separate uplink single channel or reference signal TCI). A sixth type of unified TCI (e.g., Type 6 TCI) may include uplink spatial relation information (SRI) to indicate a beam for a single uplink channel or reference signal.

In some examples, a TCI state may include at least one source reference signal to provide a reference for determining quasi-co location (QCL) information for downlink reception and/or spatial filter information for uplink transmission. For a separate downlink TCI, the source reference signal(s) in M TCIs may provide QCL information at least for UE-dedicated reception on a physical downlink shared channel (PDSCH) and for UE-dedicated reception on each or a subset of control resource sets (CORESETs) in a component carrier (CC). For a separate uplink TCI, the source reference signal(s) in N TCIs may provide a reference for determining one or more common uplink transmit spatial filters at least for a dynamic-grant or configured-grant based physical uplink shared channel (PUSCH) on all or a subset of dedicated physical uplink control channel (PUCCH) resources in a CC. In some examples, the uplink transmit spatial filter may apply to each SRS resource in resource sets configured for antenna switching, codebook-based uplink transmissions, non-codebook based uplink transmissions, or any combination thereof.

For separate downlink and uplink TCI, one instance of beam indication using DCI format 1_1 (e.g., with a downlink assignment) or DCI format 1_2 (e.g., without a downlink assignment) may be used such that one TCI field codepoint represents a pair of downlink TCI and uplink TCI states, one TCI field codepoint represents one downlink TCI state, one TCI field codepoint represents one uplink TCI state, or any combination thereof.

A UE 115 may communicate with a transmission reception point TRP (e.g., a base station 105). In some examples, the UE 115 may communicate with multiple TRPs in an mTRP mode. For instance, the UE 115 may perform simultaneous communications with a first TRP and a second TRP. In some examples, communicating with a TRP may include the UE 115 receiving DCI that indicates a TCI for the UE. When communicating in an mTRP mode, transmitting multiple DCIs to convey multiple TCI states for different channels and/or reference signals may increase a latency associated with communications between the UE 115 and at least one of the TRPs. Techniques that decrease the latency associated with conveying multiple TCI states may increase the efficiency of communications.

The present disclosure describes techniques that may decrease the latency associated with conveying multiple TCI states. For instance, the present disclosure describes one DCI indicating TCI states for multiple TRPs. In a first example, a single DCI may include multiple TCI-indication fields, where each field may indicate a respective TCI state for a respective TRP (e.g., a first TCI indication field for a first TRP and a second TCI indication field for a second TRP). In a second example, a single DCI may be configured with one TCI field whose codepoint maps to multiple TCI states (e.g., a single TCI field that maps to a first TCI state for a first TRP and a second TCI state for a second TRP). In a third example, a single DCI may be configured with one TCI field that points to one TCI. However, the TCI may be associated with multiple reference signals, where each TRP may use a different one of the multiple reference signals. Accordingly, the UE 115 may determine an associated TCI state for each TRP from a single DCI and the efficiency of wireless communications may increase.

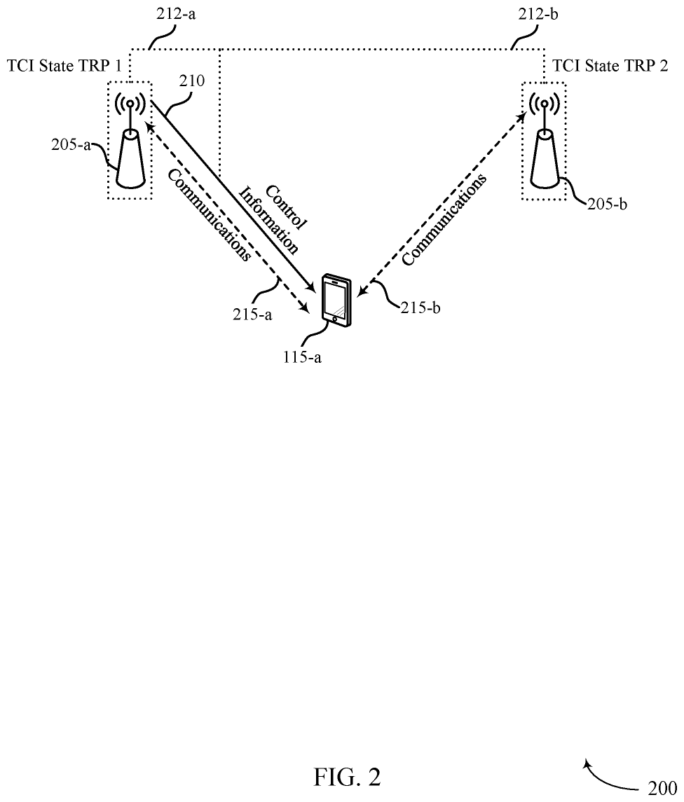

FIG. 2 illustrates an example of a wireless communications system 200 that supports unified transmission configuration indication for multiple transmission reception points in accordance with aspects of the present disclosure. In some examples, wireless communications system 200 may be implemented by one or more aspects of wireless communications system 100. For instance, TRPs 205-a and 205-b may each be an example of a base station 105 as described with reference to FIG. 1. Additionally or alternatively, UE 115-a may be an example of a UE 115 as described with reference to FIG. 1.

UE 115-a may operate in an mTRP mode with TRPs 205-a and 205-b. For instance, UE 115-a may be capable of performing simultaneous communication with TRPs 205-a and 205-b. In some examples, UE 115-a may support various unified TCI types for single TRP (sTRP) operation. In some such examples, UE 115-a may receive a single indication with either a single joint TCI state or separate TCI states for uplink channels or reference signals and downlink channels or reference signals. Additionally, UE 115-a may support unified TCI for mTRP operation. The present disclosure may describe techniques that enable UE 115-a to receive an indication of multiple beams with a single TCI indication.

In some examples, when UE 115-a is configured for mTRP operation, UE 115-a may receive an indication of multiple beams for mTRP operation in a single TCI field of DCI. For instance, UE 115-a may receive signaling (e.g., from one of TRPs 205-a and 205-b) identifying a configuration for UE 115-a to communicate with TRPs 205-a and 205-b. UE 115-a may receive control information 210 (e.g., DCI) that includes one or more TCI fields, the one or more TCI fields indicating a first TCI state 212-a for TRP 205-a and a second TCI state 212-b for TRP 205-b. UE 115-a may communicate with at least one of TRPs 205-a or 205-b according to the one or more TCI fields based on receiving control information 210. For instance, UE 115-a may perform communications 215-a with TRP 205-a, communications 215-b with TRP 205-b, or both.

In some examples, a single instance of control information 210 (e.g., a single DCI) may be configured with multiple TCI fields. For instance, the control information 210 may include a first codepoint in a first field of the control information 210 and a second codepoint in a second field of the control information 210, where the first codepoint indicates the first TCI state 212-a and the second codepoint indicates the second TCI state 212-b. In some such examples, each of the first field and the second field may indicate a respective joint TCI state, a downlink TCI state, an uplink TCI state, or any combination thereof. In some examples, the mapping order between the TCI fields and the TRPs may be predetermined based on a fixed rule or configured by higher layer signaling. Additionally or alternatively, one of the first TCI state 212-a or the second TCI state 212-b may be associated with a null TCI state for TRP 205-a or TRP 205-b. In such examples, the communicating may include communicating with the other of TRP 205-a or TRP 205-b.

In other examples, a single TCI field may be configured in control information 210, where each codepoint for a TCI field is mapped with one or more TCIs. For instance, control information 210 may include a codepoint in a field of the control information 210, where the codepoint indicates the first TCI state 212-a and the second TCI state 212-b. In some examples, the mapping order between the TCIs in a codepoint and the TRPs may be predetermined based on a fixed rule or configured by higher layer signaling. In some examples, the field may indicate two joint TCI states, two downlink TCI states, two uplink TCI states, or any combination thereof. For instance, a codepoint of the field may be mapped to two downlink TCI states and two uplink TCI states.

In other examples, a single TCI may be configured with multiple resources of reference signals providing the beam indication. For instance, the TCI may be configured with multiple reference signals for determining QCL-typeD information and/or multiple reference signals to determine spatial transmit filters. In some examples, the mapping order between the reference signals in a TCI and the TRPs may be predetermined based on a fixed rule or configured by higher layer signaling. In some such examples, UE 115-a may determine a first set of spatial parameters (e.g., QCL-typeD information), a first spatial transmit filter, or both for TRP 205-a based on a first of a set of reference signals and may determine a second set of spatial parameters, a second spatial transmit filter, or both, for TRP 205-b based on a second of the set of reference signals. In some examples, the TCI may be associated with the set of reference signals.

In some examples, UE 115-a may activate TCIs for control information 210 configured with multiple TCI fields. In one example, UE 115-a may receive, from TRP 205-a or TRP 205-b, a medium access control (MAC) control element (MAC-CE) for each TCI to be activated. For instance, UE 115-a may receive a first MAC-CE transmission indicating to activate the first TCI state 212-a for TRP 205-a and may receive a second MAC-CE transmission indicating to activate the second TCI state 212-b for TRP 205-b. In another example, UE 115-a may receive, from TRP 205-a or TRP 205-b, a single MAC-CE for activating each TCI indicated in control information 210. For instance, UE 115-a may receive a single MAC-CE transmission indicating to activate the first TCI state 212-a for TRP 205-a and the second TCI state 212-b for TRP 205-b.

In some examples, when UE 115-a is configured with mTRP operation and indicated with multiple beams in a single TCI field, UE 115-a may determine associated channels or reference signals for each beam. One technique by which UE 115-a may determine the associated channels or reference signals is via a TRP identifier (ID), which may be explicit or implicit. For instance, UE 115—may determine a first reference signal associated with the first TCI state 212-a based on a first TRP ID associated with the first reference signal and a second reference signal associated with the second TCI state 212-b based on a second TRP ID associated with the second reference signal. In some such examples, the first TCI and the second TCI may each include or be associated with a CORESET ID, a sounding reference signal (SRS) resource set ID, a close-loop index ID, or any combination thereof.

Another technique by which UE 115-a may determine the associated channels or reference signals is by a predetermined associated based on a rule. For instance, UE 115-a may apply a first QCL (e.g., QCL Type D) reference signal in a TCI to TRP 205-a and a second QCL in the same TCI to TRP 205-b. Additionally or alternatively, UE 115-a may apply the first TCI in a TCI indication field to TRP 205-a and a second TCI in the same TCI indication field to TRP 205-b. Additionally or alternatively, UE 115-a may apply a TCI in a first indication field to TRP 205-a and a second TCI in the same TCI indication field to TRP 205-b.

Yet another technique by which UE 115-a may determine the associated channels or reference signals is via higher layer configuration by RRC signaling or MAC-CE signaling. For instance, UE 115-a may receive RRC signaling or MAC-CE signaling indicating a respective set of channels, a respective set of reference signals, or both for each of the first TCI state 212-a and the second TCI state 212-b. In some examples, RRC signaling may specify TCI to be applied with which set of channels and reference signals. Additionally or alternatively, UE 115-a may receive multiple TCIs for various sets of associated channels and reference signals. Different sets of channels or reference signals may be associated with different TRPs.

In some examples, the techniques described herein may be associated with one or more advantages. For instance, indicating multiple TCI states in a single instance control information 210 (e.g., a single DCI) may be associated with decreased latency as compared to indicating multiple TCI states over multiple instances of control information 210. Accordingly, the efficiency of wireless communications may increase.

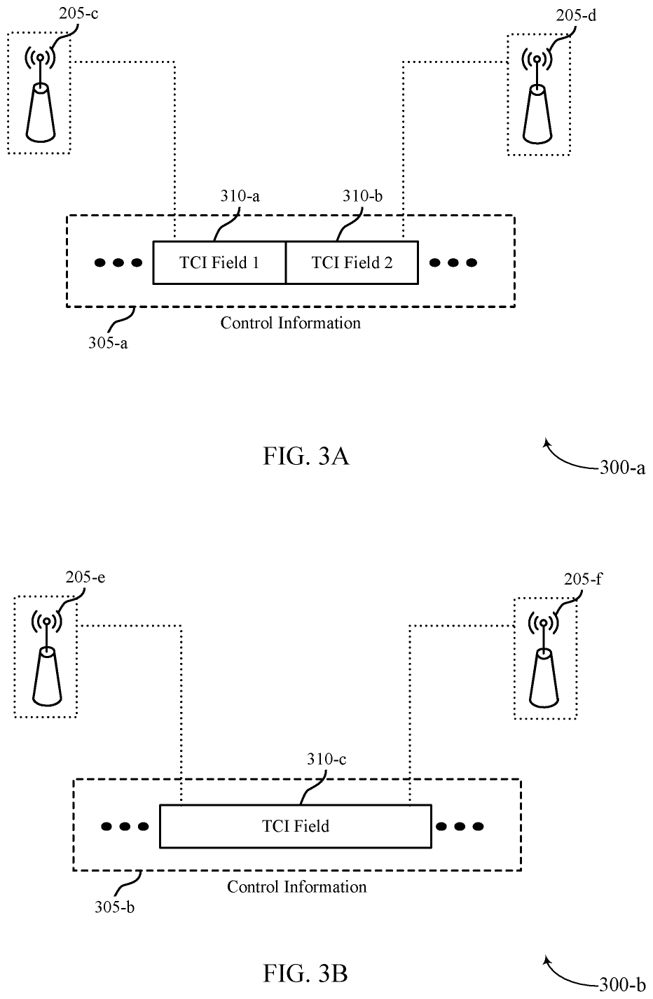

FIGS. 3A and 3B illustrate examples of TCI indication schemes 300-a and 300-b that support unified transmission configuration indication for multiple transmission reception points in accordance with aspects of the present disclosure. In some examples, TCI indication schemes 300-a and 300-b may implement one or more aspects of wireless communications system 200. For instance, TRPs 205-c, 205-d, 205-e, and 205-f may each be an example of a TRP 205-a or TRP 205-b as described with reference to FIG. 2. Additionally or alternatively, control information 305-a or 305-b may be an example of control information 210 as described with reference to FIG. 2.

As illustrated in TCI indication scheme 300-a, TRP 205-c or TRP 205-d may transmit control information 305-a to a UE. Control information 305-a may be configured with multiple TCI indication fields (e.g., TCI indication fields 310-a and 310-b). In some examples, the TCI indication fields may be configured per TRP. For instance, each TCI indication field may configure a TRP with one joint TCI, one downlink TCI, one uplink TCI, or one downlink TCI and one uplink TCI. To activate the TCIs for control information 305-a configured with multiple TCI indication fields, multiple MAC-CE may be received that indicate to activate TCIs for respective TCI indication fields. For instance, for TCI field 310-a, a first codepoint may indicate a first TCI to be activated by a first MAC-CE and, for TCI field 310-b, the first codepoint may indicate a second TCI ID that is to be activated by a second MAC-CE. Additionally or alternatively, a single MAC-CE may be received for activating TCIs for all TCI indication fields in a single DCI. For instance, for TCI field 310-a, a first cyclic prefix may indicate a first TCI ID activated by a MAC-CE, and for TCI field 310-b, the first codepoint may indicate a TCI ID activated by the same MAC-CE. In some examples, the TCI indication field may have one codepoint reserved not to indicate any TCIs (e.g., the corresponding TRP may not be used for communications).

As illustrated in TCI indication scheme 300-b, TRP 205-e or TRP 205-f may transmit control information 305-b to a UE. Control information 305-b may be configured with a single TCI indication field 310-c, where each codepoint for the TCI indication field 310-c is mapped with one or more TCIs according to MAC-CE that activates the one or more TCIs for the codepoint. In some examples, the TCI field 310-c may be directed for each TRP with which the UE communicates. In some examples, the TCI field may indicate multiple (e.g., two or more) joint TCIs, multiple (e.g., two or more) downlink TCIs, multiple (e.g., two or more) uplink TCIs, or multiple (e.g., two or more) downlink TCIs and multiple (e.g., two or more) downlink TCIs. Additionally or alternatively, a single TCI may be configured with multiple resources for reference signals providing beam indications. For instance, the TCI may be configured with multiple reference signals for determining QCL-typeD information or multiple reference signals to determine spatial transmit filters. In some examples, the techniques described herein may be applicable to both single DCI (sDCI) based mTRP and multi-DCI (mDCI) based mTRP.

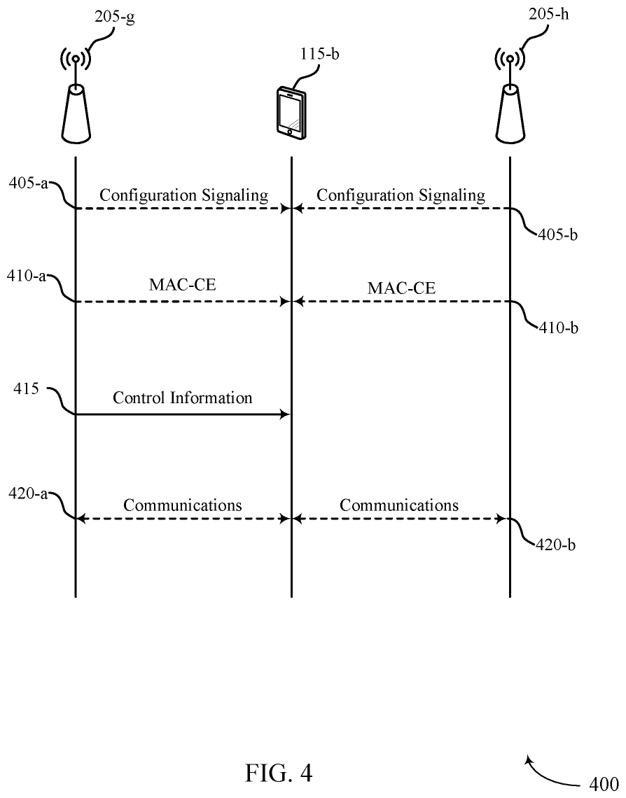

FIG. 4 illustrates an example of a process flow 400 that supports unified transmission configuration indication for multiple transmission reception points in accordance with aspects of the present disclosure. In some examples, process flow 400 may be implemented by one or more aspects of wireless communications systems 100 and/or 200. For instance, TRP 205-g and 205-h may each be an example of a TRP 205-a or 205-b as described with reference to FIG. 2 and UE 115-b may be an example of a UE 115-a as described with reference to FIG. 2 and/or a UE 115 as described with reference to FIG. 1.

At 405-a, TRP 205-g may transmit configuration signaling to UE 115-b. Alternatively, at 405-b, TRP 205-h may transmit the configuration signaling to UE 115-b. The configuration signaling may identify a configuration for UE 115-b to communicate with TRP 205-g and TRP 205-h. The configuration may include the configuration for a list of TCI states, a number of TCI fields in a DCI, or both. For instance, UE 115-b may receive RRC configurations for TCI states and the RRC configurations may configure TCI fields for a DCI.

At 410-a, TRP 205-g may transmit a respective MAC-CE to UE 115-b. Additionally or alternatively, at 410-b, TRP 205-h may transmit a respective MAC-CE to UE 115-b. In some examples, UE 115-b may receive a first MAC-CE transmission indicating to activate a first TCI state for TRP 205-g (e.g., the first TCI state indicated at 415) and may receive a second MAC-CE transmission indicating to activate a second TCI state for TRP 205-h (e.g., the second TCI state indicated at 415). Alternatively, UE 115-b may receive a single MAC-CE transmission indicating to activate the first TCI state for TRP 205-g and the second TCI state for TRP 205-h.

At 415, TRP 205-g may transmit control information (e.g., a downlink control message, such as DCI) that includes one or more TCI fields, the one or more TCI fields indicating a first TCI state for TRP 205-g and a second TCI state for TRP 205-h. In some examples, the control information may include a first codepoint in a first field of the control information and a second codepoint in a second field of the control information. In some such examples, the first codepoint may indicate the first TCI state and the second codepoint may indicate the second TCI state. In some examples, each of the first field and the second field may indicate a respective joint TCI state, a downlink TCI state, or any combination thereof. In some examples, the control information may include a codepoint in a field of the downlink control information, where the codepoint indicates the first TCI state and the second TCI state. In some such examples, the field may indicate two join TCI states, two downlink TCI states, two uplink TCI states, or any combination thereof.

At 420-a, UE 115-b may communicate with TRP 205-g according to the one or more TCIs based on receiving the control information. Additionally or alternatively, at 420-b, UE 115-b may communicate with TRP 205-h according to the one or more TCIs based on receiving the control information. In some examples, one of the first TCI state or the second TCI state is associated with a null TCI state for one of TRP 205-g or 205-h. In some such examples, UE 115-b may communicate with the other of TRP 205-g or 205-h (e.g., the TRP indicated by the null TCI state would not be associated with a TCI state for the grant in the DCI). In some examples, performing the communicating may be based on receiving the first and second MAC-CE transmissions. In some examples, performing the communicating may be based on receiving the MAC-CE.

In some examples, UE 115-b may receive RRC signaling or MAC-CE signaling indicating a respective set of channels, a respective set of reference signals, or both for each of the first TCI state and the second TCI state. In some examples, the one or more TCIs may include a single TCI, where the single TCI is associated with a set of reference signals. In some such examples, UE 115-a may determine a first set of spatial parameters, a first spatial transmit filter, or both for TRP 205-g based on a first of the set of reference signals and a second set of spatial parameters, a second spatial transmit filter, or both for TRP 205-h based on a second of the set of reference signals. In some examples, UE 115-b may determine a first reference signal associated with the first TCI state based on a first TRP ID associated with the first reference signal and a second reference signal associate with the second TCI state based on a second TRP ID associated with the second reference signal. In some such examples, the first TRP ID and the second TRP ID may each include a CORESET ID, an SRS resource set ID, a close-loop index ID, or any combination thereof.

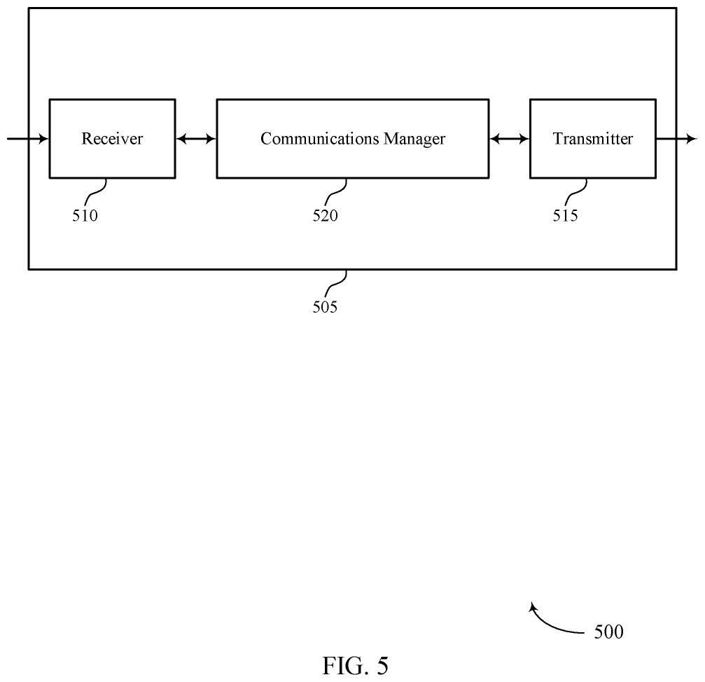

FIG. 5 shows a block diagram 500 of a device 505 that supports unified transmission configuration indication for multiple transmission reception points in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to unified transmission configuration indication for multiple transmission reception points). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to unified transmission configuration indication for multiple transmission reception points). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of unified transmission configuration indication for multiple transmission reception points as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for receiving signaling identifying a configuration for the UE to communicate with a first transmission reception point and a second transmission reception point. The communications manager 520 may be configured as or otherwise support a means for receiving a single downlink control message that includes one or more transmission configuration indicators, the one or more transmission configuration indicators indicating a first transmission configuration indicator state for the first transmission reception point and a second transmission configuration indicator state for the second transmission reception point. The communications manager 520 may be configured as or otherwise support a means for communicating with at least one of the first transmission reception point or the second transmission reception point according to the one or more transmission configuration indicators based on receiving the single downlink control message.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for the device 505 to receive an indication of multiple TCI states in a single instance of control information. Receiving the indication of multiple TCI states in the single instance of control information may be associated with reduced latency as compared to receiving the indication of multiple TCI states over multiple instances of control information.

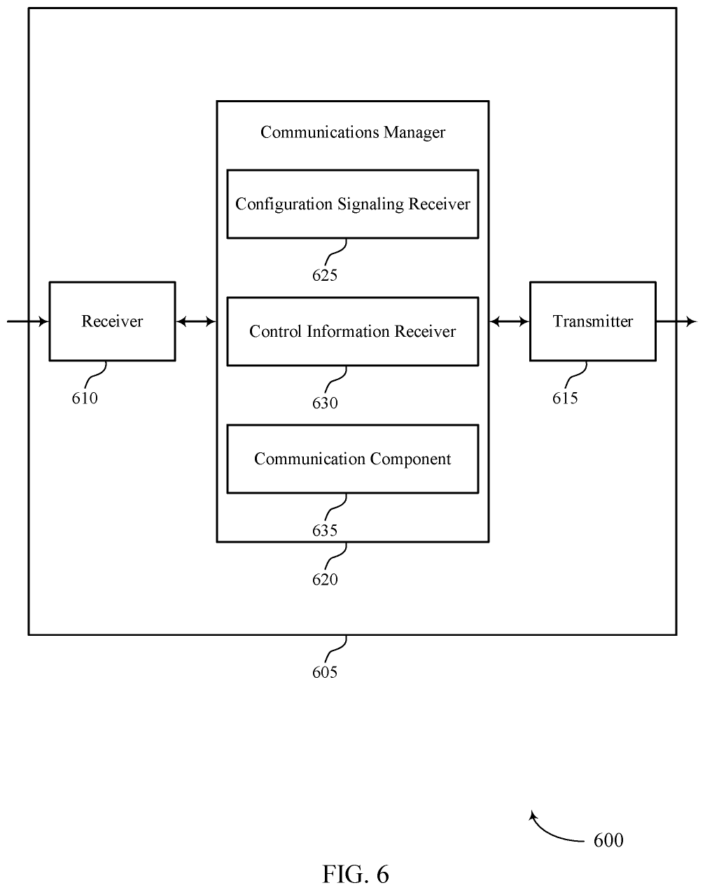

FIG. 6 shows a block diagram 600 of a device 605 that supports unified transmission configuration indication for multiple transmission reception points in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to unified transmission configuration indication for multiple transmission reception points). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to unified transmission configuration indication for multiple transmission reception points). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of unified transmission configuration indication for multiple transmission reception points as described herein. For example, the communications manager 620 may include a configuration signaling receiver 625, a control information receiver 630, a communication component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The configuration signaling receiver 625 may be configured as or otherwise support a means for receiving signaling identifying a configuration for the UE to communicate with a first transmission reception point and a second transmission reception point. The control information receiver 630 may be configured as or otherwise support a means for receiving a single downlink control message that includes one or more transmission configuration indicators, the one or more transmission configuration indicators indicating a first transmission configuration indicator state for the first transmission reception point and a second transmission configuration indicator state for the second transmission reception point. The communication component 635 may be configured as or otherwise support a means for communicating with at least one of the first transmission reception point or the second transmission reception point according to the one or more transmission configuration indicators based on receiving the single downlink control message.

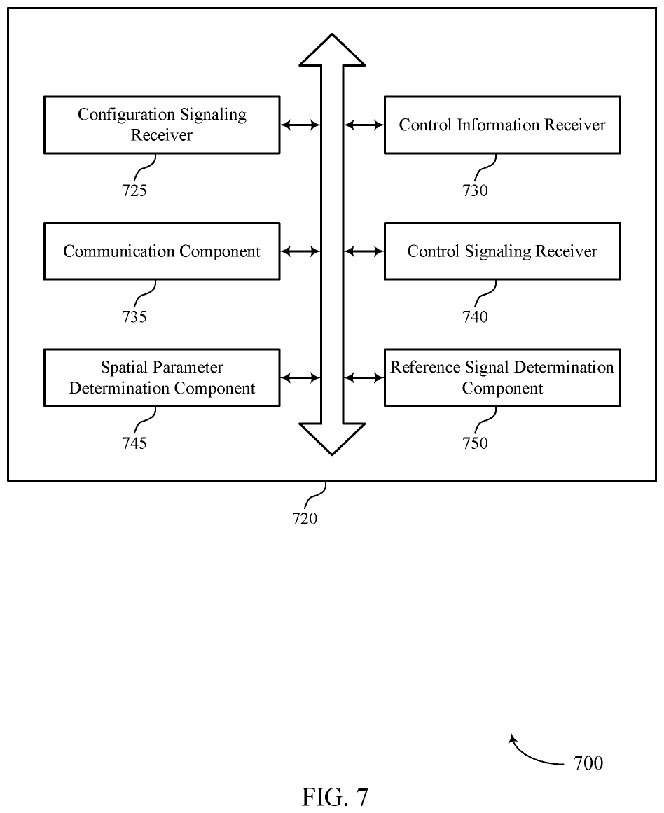

FIG. 7 shows a block diagram 700 of a communications manager 720 that supports unified transmission configuration indication for multiple transmission reception points in accordance with aspects of the present disclosure. The communications manager 720 may be an example of aspects of a communications manager 520, a communications manager 620, or both, as described herein. The communications manager 720, or various components thereof, may be an example of means for performing various aspects of unified transmission configuration indication for multiple transmission reception points as described herein. For example, the communications manager 720 may include a configuration signaling receiver 725, a control information receiver 730, a communication component 735, a control signaling receiver 740, a spatial parameter determination component 745, a reference signal determination component 750, or any combination thereof. Each of these components may communicate, directly or indirectly, with one another (e.g., via one or more buses).

The communications manager 720 may support wireless communication at a UE in accordance with examples as disclosed herein. The configuration signaling receiver 725 may be configured as or otherwise support a means for receiving signaling identifying a configuration for the UE to communicate with a first transmission reception point and a second transmission reception point. The control information receiver 730 may be configured as or otherwise support a means for receiving a single downlink control message that includes one or more transmission configuration indicators, the one or more transmission configuration indicators indicating a first transmission configuration indicator state for the first transmission reception point and a second transmission configuration indicator state for the second transmission reception point. The communication component 735 may be configured as or otherwise support a means for communicating with at least one of the first transmission reception point or the second transmission reception point according to the one or more transmission configuration indicators based on receiving the single downlink control message.

In some examples, to support receiving the single downlink control message that includes the one or more transmission configuration indicators, the control information receiver 730 may be configured as or otherwise support a means for receiving the single downlink control message including a first codepoint in a first field of the single downlink control message and a second codepoint in a second field of the single downlink control message, where the first codepoint indicates the first transmission configuration indicator state and the second codepoint indicates the second transmission configuration indicator state.

In some examples, each of the first field and the second field indicates a respective joint transmission configuration indicator state, a downlink transmission configuration indicator state, an uplink transmission configuration indicator state, or any combination thereof.

In some examples, to support communicating, the communication component 735 may be configured as or otherwise support a means for communicating with the other of the first transmission reception point or the second transmission reception point.

In some examples, to support receiving the single downlink control message that includes the one or more transmission configuration indicators, the control information receiver 730 may be configured as or otherwise support a means for receiving the single downlink control message including a codepoint in a field of the single downlink control message, where the codepoint indicates the first transmission configuration indicator state and the second transmission configuration indicator state.

In some examples, the field indicates two joint transmission configuration indicator states, two downlink transmission configuration indicator states, two uplink configuration indicator states, or any combination thereof.

In some examples, the control signaling receiver 740 may be configured as or otherwise support a means for receiving a first medium access control (MAC) control element (MAC-CE) transmission indicating to activate the first transmission configuration indicator state for the first transmission reception point, where communicating with the first transmission reception point is based on receiving the first MAC-CE transmission. In some examples, the control signaling receiver 740 may be configured as or otherwise support a means for receiving a second MAC-CE transmission indicating to activate the second transmission configuration indicator state for the second transmission reception point, where communicating with the second transmission reception point is based on receiving the second MAC-CE transmission.

In some examples, the control signaling receiver 740 may be configured as or otherwise support a means for receiving a medium access control (MAC) control element (MAC-CE) transmission indicating to activate the first transmission configuration indicator state for the first transmission reception point and the second transmission configuration indicator state for the second transmission reception point, where communicating with the first transmission reception point and the second transmission reception point is based on receiving the MAC-CE transmission.

In some examples, the control information receiver 730 may be configured as or otherwise support a means for receiving radio resource control signaling or medium access control (MAC) control element signaling indicating a respective set of channels, a respective set of reference signals, or both for each of the first transmission configuration indicator state and the second transmission configuration indicator state.

In some examples, the one or more transmission configuration indicators include a single transmission configuration indicator, and the spatial parameter determination component 745 may be configured as or otherwise support a means for determining a first set of spatial parameters, a first spatial transmit filter, or both, for the first transmission reception point based on a first of the set of multiple reference signals and a second set of spatial parameters, a second spatial transmit filter, or both, for the second transmission reception point based on a second of the set of multiple reference signals.

In some examples, the reference signal determination component 750 may be configured as or otherwise support a means for determining a first reference signal associated with the first transmission configuration indicator state based on a first transmission reception point identifier associated with the first reference signal and a second reference signal associated with the second transmission configuration indicator state based on a second transmission reception point identifier associated with the second reference signal.

In some examples, the first transmission reception point identifier and the second transmission reception point identifier each include a control resource set pool identifier, a sounding reference signal resource set identifier, a close-loop index identifier, or any combination thereof.

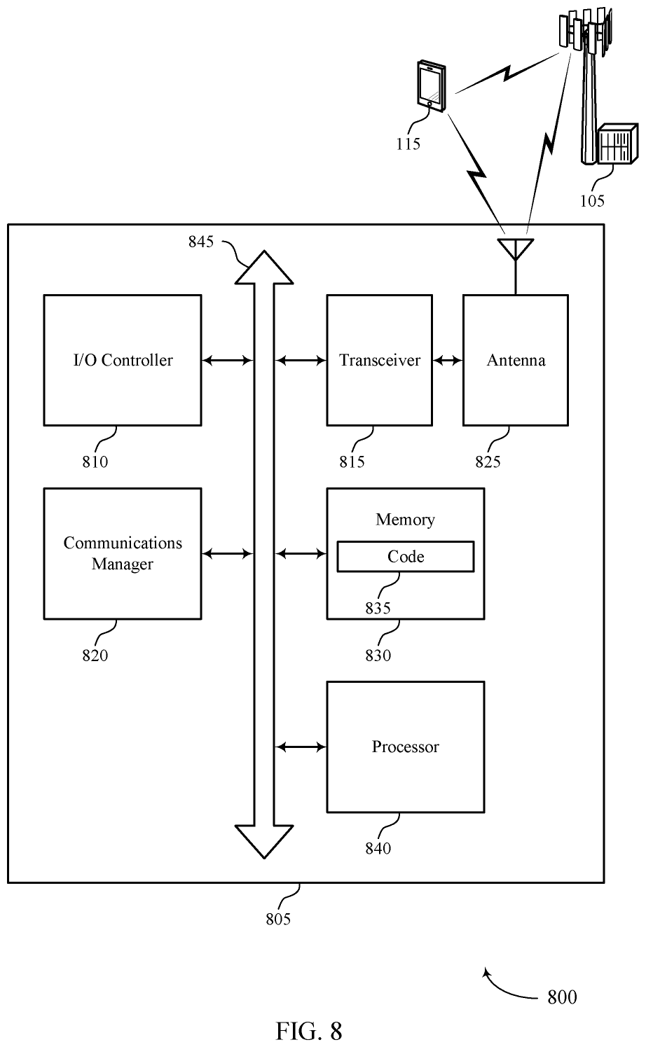

FIG. 8 shows a diagram of a system 800 including a device 805 that supports unified transmission configuration indication for multiple transmission reception points in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2R, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting unified transmission configuration indication for multiple transmission reception points). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving signaling identifying a configuration for the UE to communicate with a first transmission reception point and a second transmission reception point. The communications manager 820 may be configured as or otherwise support a means for receiving a single downlink control message that includes one or more transmission configuration indicators, the one or more transmission configuration indicators indicating a first transmission configuration indicator state for the first transmission reception point and a second transmission configuration indicator state for the second transmission reception point. The communications manager 820 may be configured as or otherwise support a means for communicating with at least one of the first transmission reception point or the second transmission reception point according to the one or more transmission configuration indicators based on receiving the single downlink control message.

By including or configuring the communications manager 820 in accordance with examples as described herein, the device 805 may support techniques for the device 805 to receive an indication of multiple TCI states in a single instance of control information. Receiving the indication of multiple TCI states in the single instance of control information may be associated with reduced latency as compared to receiving the indication of multiple TCI states over multiple instances of control information.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of unified transmission configuration indication for multiple transmission reception points as described herein, or the processor 840 and the memory 830 may be otherwise configured to perform or support such operations.

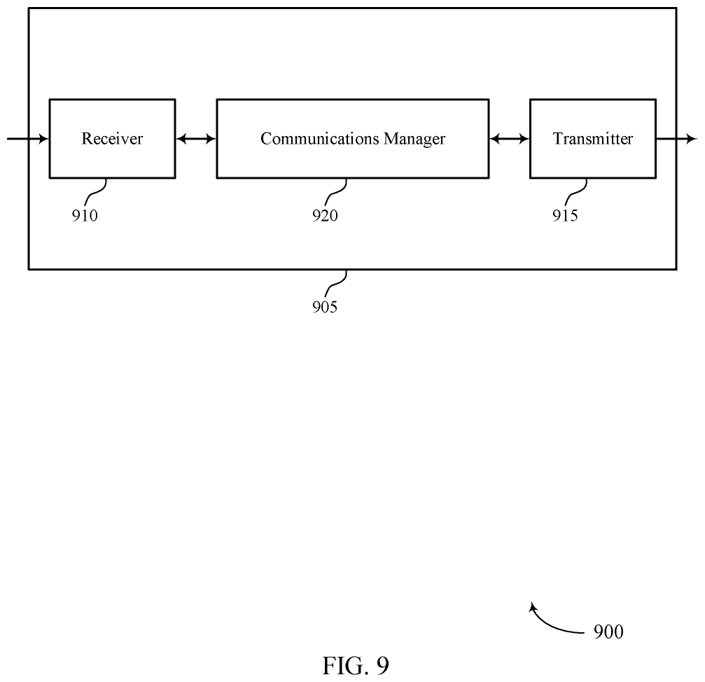

FIG. 9 shows a block diagram 900 of a device 905 that supports unified transmission configuration indication for multiple transmission reception points in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to unified transmission configuration indication for multiple transmission reception points). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to unified transmission configuration indication for multiple transmission reception points). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of unified transmission configuration indication for multiple transmission reception points as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a network in accordance with examples as disclosed herein. For example, the communications manager 920 may be configured as or otherwise support a means for transmitting, to a UE, signaling identifying a configuration for the UE to communicate with a first transmission reception point and a second transmission reception point of the network. The communications manager 920 may be configured as or otherwise support a means for transmitting, to the UE, a single downlink control message that includes one or more transmission configuration indicators, the one or more transmission configuration indicators indicating a first transmission configuration indicator state for the first transmission reception point and a second transmission configuration indicator state for the second transmission reception point. The communications manager 920 may be configured as or otherwise support a means for communicating, from at least one of the first transmission reception point or the second transmission reception point, with the UE according to the one or more transmission configuration indicators based on transmitting the single downlink control message.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for the device 905 to transmit an indication of multiple TCI states in a single instance of control information. Transmitting the indication of multiple TCI states in the single instance of control information may be associated with reduced latency as compared to transmitting the indication of multiple TCI states over multiple instances of control information.

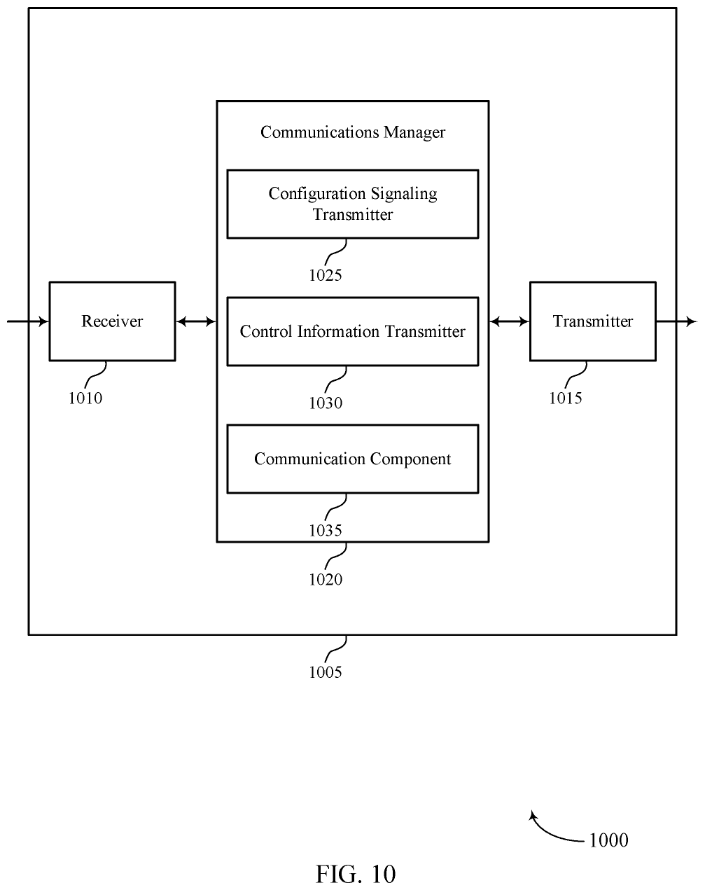

FIG. 10 shows a block diagram 1000 of a device 1005 that supports unified transmission configuration indication for multiple transmission reception points in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to unified transmission configuration indication for multiple transmission reception points). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to unified transmission configuration indication for multiple transmission reception points). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of unified transmission configuration indication for multiple transmission reception points as described herein. For example, the communications manager 1020 may include a configuration signaling transmitter 1025, a control information transmitter 1030, a communication component 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a network in accordance with examples as disclosed herein. The configuration signaling transmitter 1025 may be configured as or otherwise support a means for transmitting, to a UE, signaling identifying a configuration for the UE to communicate with a first transmission reception point and a second transmission reception point of the network. The control information transmitter 1030 may be configured as or otherwise support a means for transmitting, to the UE, a single downlink control message that includes one or more transmission configuration indicators, the one or more transmission configuration indicators indicating a first transmission configuration indicator state for the first transmission reception point and a second transmission configuration indicator state for the second transmission reception point. The communication component 1035 may be configured as or otherwise support a means for communicating, from at least one of the first transmission reception point or the second transmission reception point, with the UE according to the one or more transmission configuration indicators based on transmitting the single downlink control message.

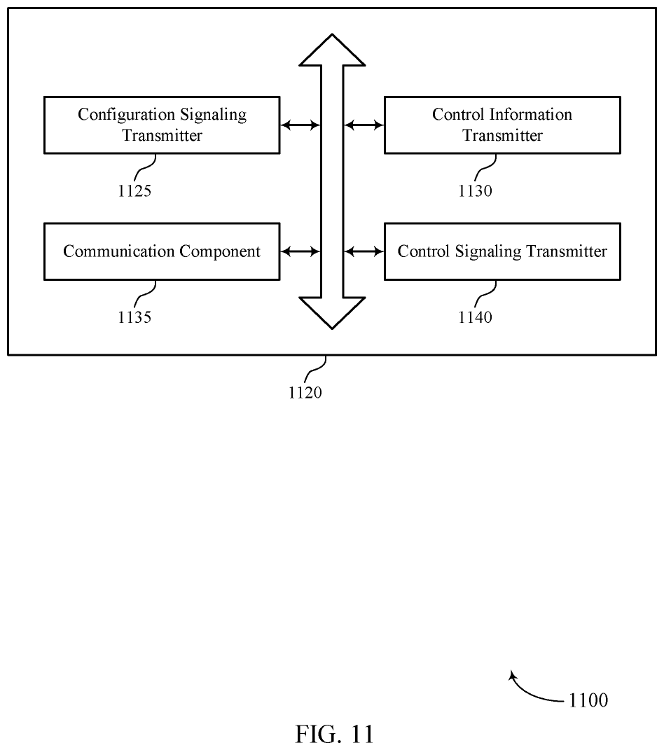

FIG. 11 shows a block diagram 1100 of a communications manager 1120 that supports unified transmission configuration indication for multiple transmission reception points in accordance with aspects of the present disclosure. The communications manager 1120 may be an example of aspects of a communications manager 920, a communications manager 1020, or both, as described herein. The communications manager 1120, or various components thereof, may be an example of means for performing various aspects of unified transmission configuration indication for multiple transmission reception points as described herein. For example, the communications manager 1120 may include a configuration signaling transmitter 1125, a control information transmitter 1130, a communication component 1135, a control signaling transmitter 1140, or any combination thereof. Each of these components may communicate, directly or indirectly, with one another (e.g., via one or more buses).

The communications manager 1120 may support wireless communication at a network in accordance with examples as disclosed herein. The configuration signaling transmitter 1125 may be configured as or otherwise support a means for transmitting, to a UE, signaling identifying a configuration for the UE to communicate with a first transmission reception point and a second transmission reception point of the network. The control information transmitter 1130 may be configured as or otherwise support a means for transmitting, to the UE, a single downlink control message that includes one or more transmission configuration indicators, the one or more transmission configuration indicators indicating a first transmission configuration indicator state for the first transmission reception point and a second transmission configuration indicator state for the second transmission reception point. The communication component 1135 may be configured as or otherwise support a means for communicating, from at least one of the first transmission reception point or the second transmission reception point, with the UE according to the one or more transmission configuration indicators based on transmitting the single downlink control message.

In some examples, to support transmitting the single downlink control message that includes the one or more transmission configuration indicators, the control information transmitter 1130 may be configured as or otherwise support a means for transmitting, to the UE, the single downlink control message including a first codepoint in a first field of the single downlink control message and a second codepoint in a second field of the single downlink control message, where the first codepoint indicates the first transmission configuration indicator state and the second codepoint indicates the second transmission configuration indicator state.

In some examples, each of the first field and the second field indicates a respective joint transmission configuration indicator state, a downlink transmission configuration indicator state, an uplink configuration indicator state, or any combination thereof.

In some examples, to support communicating, the communication component 1135 may be configured as or otherwise support a means for communicating with the UE from the other of the first transmission reception point or the second transmission reception point.

In some examples, to support transmitting the single downlink control message that includes the one or more transmission configuration indicators, the control information transmitter 1130 may be configured as or otherwise support a means for transmitting, to the UE, a single downlink control message including a codepoint in a field of the single downlink control message, where the codepoint indicates the first transmission configuration indicator state and the second transmission configuration indicator state.

In some examples, the field indicates two joint transmission configuration indicator states, two downlink transmission configuration indicator states, two uplink configuration indicator states, or any combination thereof.

In some examples, the control signaling transmitter 1140 may be configured as or otherwise support a means for transmitting a first medium access control (MAC) control element (MAC-CE) transmission indicating to activate the first transmission configuration indicator state for the first transmission reception point, where communicating from the first transmission reception point with the UE is based on transmitting the first MAC-CE transmission. In some examples, the control signaling transmitter 1140 may be configured as or otherwise support a means for transmitting a second MAC-CE transmission indicating to activate the second transmission configuration indicator state for the second transmission reception point, where communicating from the second transmission reception point with the UE is based on transmitting the second MAC-CE transmission.

In some examples, the control signaling transmitter 1140 may be configured as or otherwise support a means for transmitting a medium access control (MAC) control element (MAC-CE) transmission indicating to activate the first transmission configuration indicator state for the first transmission reception point and the second transmission configuration indicator state for the second transmission reception point, where communicating from the first transmission reception point and the second transmission reception point with the UE is based on transmitting the MAC-CE transmission.

In some examples, the control signaling transmitter 1140 may be configured as or otherwise support a means for transmitting radio resource control signaling or medium access control (MAC) control element signaling indicating a respective set of channels, a respective set of reference signals, or both for each of the first transmission configuration indicator state.

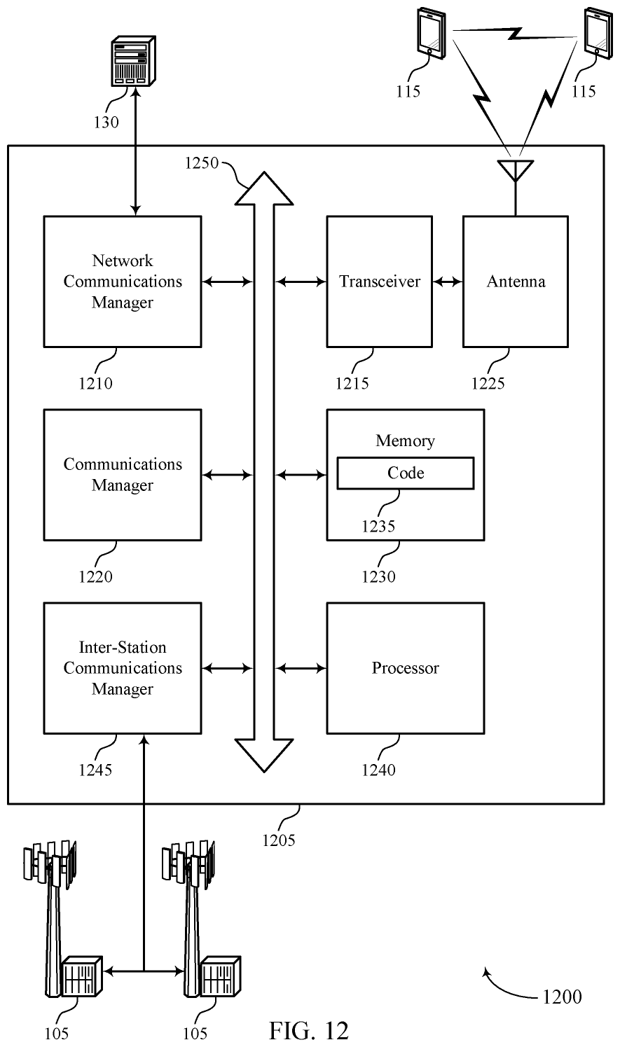

FIG. 12 shows a diagram of a system 1200 including a device 1205 that supports unified transmission configuration indication for multiple transmission reception points in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting unified transmission configuration indication for multiple transmission reception points). For example, the device 1205 or a component of the device 1205 may include a processor 1240 and memory 1230 coupled with or to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communication at a network in accordance with examples as disclosed herein. For example, the communications manager 1220 may be configured as or otherwise support a means for transmitting, to a UE, signaling identifying a configuration for the UE to communicate with a first transmission reception point and a second transmission reception point of the network. The communications manager 1220 may be configured as or otherwise support a means for transmitting, to the UE, a single downlink control message that includes one or more transmission configuration indicators, the one or more transmission configuration indicators indicating a first transmission configuration indicator state for the first transmission reception point and a second transmission configuration indicator state for the second transmission reception point. The communications manager 1220 may be configured as or otherwise support a means for communicating, from at least one of the first transmission reception point or the second transmission reception point, with the UE according to the one or more transmission configuration indicators based on transmitting the single downlink control message.

By including or configuring the communications manager 1220 in accordance with examples as described herein, the device 1205 may support techniques for the device 1205 to transmit an indication of multiple TCI states in a single instance of control information. Transmitting the indication of multiple TCI states in the single instance of control information may be associated with reduced latency as compared to transmitting the indication of multiple TCI states over multiple instances of control information.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of unified transmission configuration indication for multiple transmission reception points as described herein, or the processor 1240 and the memory 1230 may be otherwise configured to perform or support such operations.

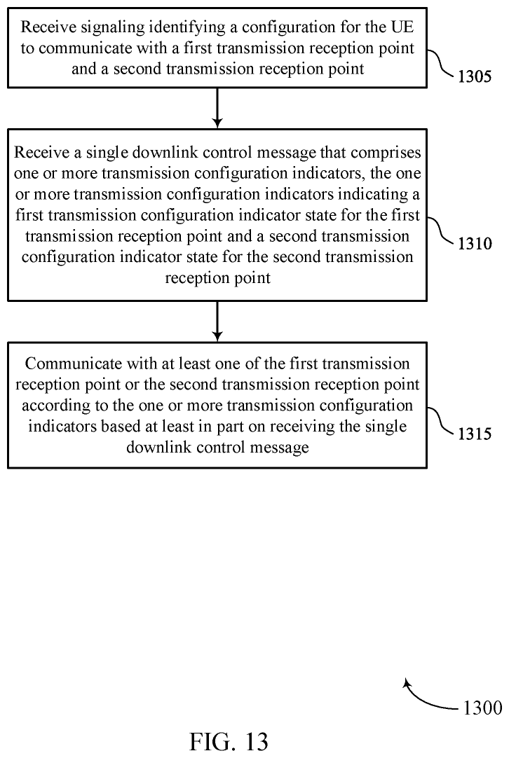

FIG. 13 shows a flowchart illustrating a method 1300 that supports unified transmission configuration indication for multiple transmission reception points in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving signaling identifying a configuration for the UE to communicate with a first transmission reception point and a second transmission reception point. The operations of 1305 may be performed in accordance with examples as disclosed herein. In some examples, aspects of the operations of 1305 may be performed by a configuration signaling receiver 725 as described with reference to FIG. 7. Additionally or alternatively, means for performing 1305 may, but not necessarily, include, for example, I/O controller 810, transceiver 815, communications manager 820, antenna 825, memory 830, code 835, processor 840, and/or bus 845.

At 1310, the method may include receiving a single downlink control message (e.g., a DCI message) that includes one or more transmission configuration indicators, the one or more transmission configuration indicators indicating a first transmission configuration indicator state for the first transmission reception point and a second transmission configuration indicator state for the second transmission reception point. The operations of 1310 may be performed in accordance with examples as disclosed herein. In some examples, aspects of the operations of 1310 may be performed by a control information receiver 730 as described with reference to FIG. 7. Additionally or alternatively, means for performing 1310 may, but not necessarily, include, for example, I/O controller 810, transceiver 815, communications manager 820, antenna 825, memory 830, code 835, processor 840, and/or bus 845

At 1315, the method may include communicating with at least one of the first transmission reception point or the second transmission reception point according to the one or more transmission configuration indicators based on receiving the single downlink control message. The operations of 1315 may be performed in accordance with examples as disclosed herein. In some examples, aspects of the operations of 1315 may be performed by a communication component 735 as described with reference to FIG. 7. Additionally or alternatively, means for performing 1315 may, but not necessarily, include, for example, I/O controller 810, transceiver 815, communications manager 820, antenna 825, memory 830, code 835, processor 840, and/or bus 845

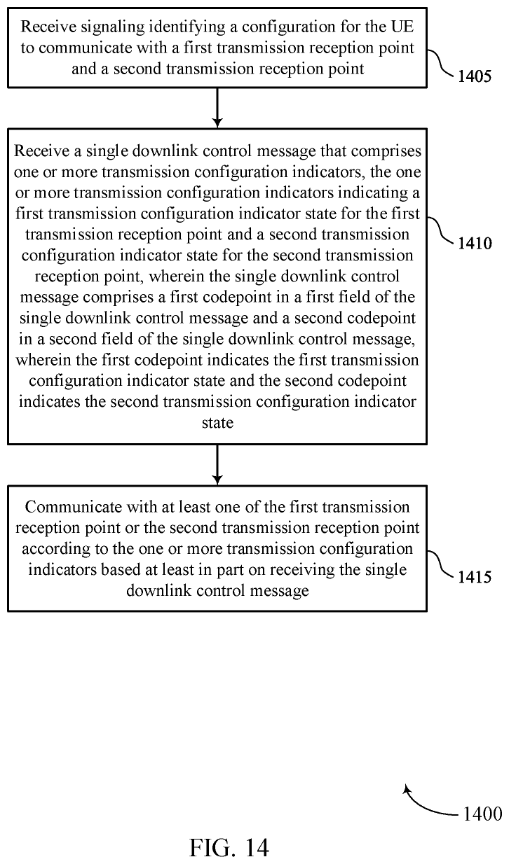

FIG. 14 shows a flowchart illustrating a method 1400 that supports unified transmission configuration indication for multiple transmission reception points in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving signaling identifying a configuration for the UE to communicate with a first transmission reception point and a second transmission reception point. The operations of 1405 may be performed in accordance with examples as disclosed herein. In some examples, aspects of the operations of 1405 may be performed by a configuration signaling receiver 725 as described with reference to FIG. 7. Additionally or alternatively, means for performing 1405 may, but not necessarily, include, for example, I/O controller 810, transceiver 815, communications manager 820, antenna 825, memory 830, code 835, processor 840, and/or bus 845

At 1410, the method may include receiving a single downlink control message (e.g., a DCI message) that includes one or more transmission configuration indicators, the one or more transmission configuration indicators indicating a first transmission configuration indicator state for the first transmission reception point and a second transmission configuration indicator state for the second transmission reception point, where the single downlink control message comprises a first codepoint in a first field of the single downlink control message and a second codepoint in a second field of the single downlink control message, where the first codepoint indicates the first transmission configuration indicator state and the second codepoint indicates the second transmission configuration indicator state. The operations of 1410 may be performed in accordance with examples as disclosed herein. In some examples, aspects of the operations of 1410 may be performed by a control information receiver 730 as described with reference to FIG. 7. Additionally or alternatively, means for performing 1410 may, but not necessarily, include, for example, I/O controller 810, transceiver 815, communications manager 820, antenna 825, memory 830, code 835, processor 840, and/or bus 845.

At 1415, the method may include communicating with at least one of the first transmission reception point or the second transmission reception point according to the one or more transmission configuration indicators based on receiving the single downlink control message. The operations of 1415 may be performed in accordance with examples as disclosed herein. In some examples, aspects of the operations of 1415 may be performed by a communication component 735 as described with reference to FIG. 7. Additionally or alternatively, means for performing 1415 may, but not necessarily, include, for example, I/O controller 810, transceiver 815, communications manager 820, antenna 825, memory 830, code 835, processor 840, and/or bus 845.

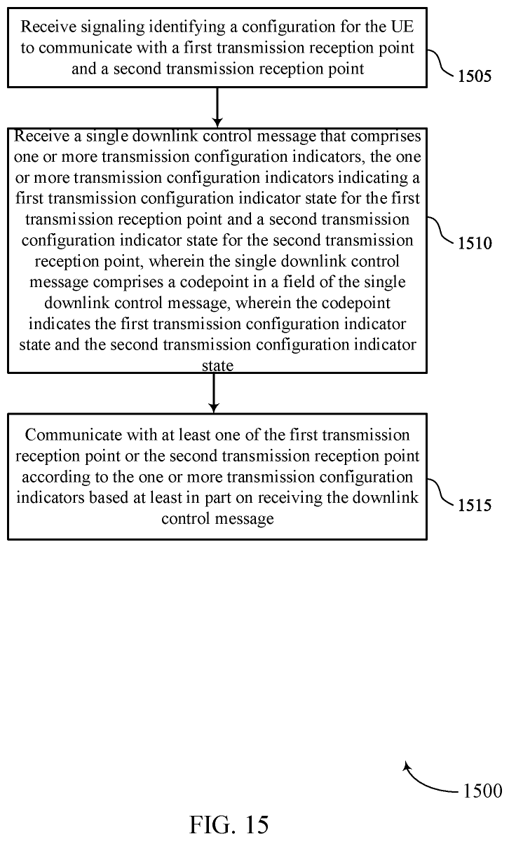

FIG. 15 shows a flowchart illustrating a method 1500 that supports unified transmission configuration indication for multiple transmission reception points in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include receiving signaling identifying a configuration for the UE to communicate with a first transmission reception point and a second transmission reception point. The operations of 1505 may be performed in accordance with examples as disclosed herein. In some examples, aspects of the operations of 1505 may be performed by a configuration signaling receiver 725 as described with reference to FIG. 7. Additionally or alternatively, means for performing 1505 may, but not necessarily, include, for example, I/O controller 810, transceiver 815, communications manager 820, antenna 825, memory 830, code 835, processor 840, and/or bus 845.

At 1510, the method may include receiving a single downlink control message (e.g., a DCI message) that includes one or more transmission configuration indicators, the one or more transmission configuration indicators indicating a first transmission configuration indicator state for the first transmission reception point and a second transmission configuration indicator state for the second transmission reception point, where the single downlink control message comprises a codepoint in a field of the single downlink control message, where the codepoint indicates the first transmission configuration indicator state and the second transmission configuration indicator state. The operations of 1510 may be performed in accordance with examples as disclosed herein. In some examples, aspects of the operations of 1510 may be performed by a control information receiver 730 as described with reference to FIG. 7. Additionally or alternatively, means for performing 1510 may, but not necessarily, include, for example, I/O controller 810, transceiver 815, communications manager 820, antenna 825, memory 830, code 835, processor 840, and/or bus 845

At 1515, the method may include communicating with at least one of the first transmission reception point or the second transmission reception point according to the one or more transmission configuration indicators based on receiving the single downlink control message. The operations of 1515 may be performed in accordance with examples as disclosed herein. In some examples, aspects of the operations of 1515 may be performed by a communication component 735 as described with reference to FIG. 7. Additionally or alternatively, means for performing 1515 may, but not necessarily, include, for example, I/O controller 810, transceiver 815, communications manager 820, antenna 825, memory 830, code 835, processor 840, and/or bus 845

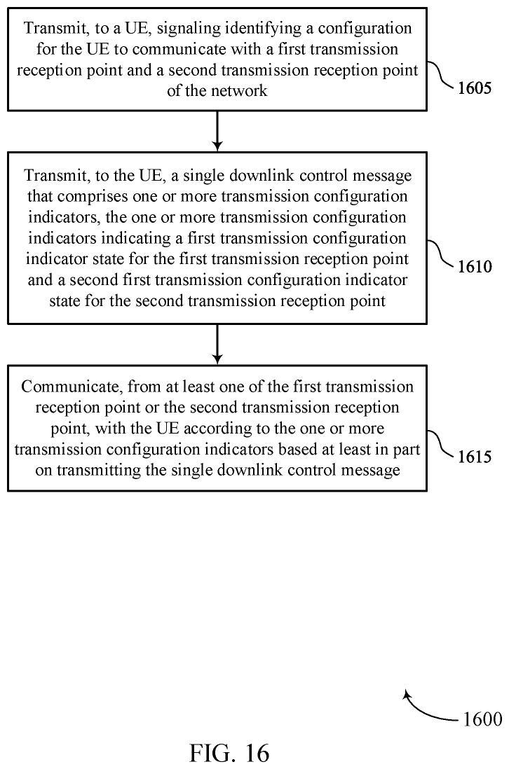

FIG. 16 shows a flowchart illustrating a method 1600 that supports unified transmission configuration indication for multiple transmission reception points in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include transmitting, to a UE, signaling identifying a configuration for the UE to communicate with a first transmission reception point and a second transmission reception point of the network. The operations of 1605 may be performed in accordance with examples as disclosed herein. In some examples, aspects of the operations of 1605 may be performed by a configuration signaling transmitter 1125 as described with reference to FIG. 11. Additionally or alternatively, means for performing 1605 may, but not necessarily, include, for example, network communications manager 1210, transceiver 1215, communications manager 1220, antenna 1225, memory 1230, code 1235, processor 1240, inter-station communications manager 1245, and/or bus 1250.

At 1610, the method may include transmitting, to the UE, single downlink control message (e.g., a DCI message) that includes one or more transmission configuration indicators, the one or more transmission configuration indicators indicating a first transmission configuration indicator state for the first transmission reception point and a second transmission configuration indicator state for the second transmission reception point. The operations of 1610 may be performed in accordance with examples as disclosed herein. In some examples, aspects of the operations of 1610 may be performed by a control information transmitter 1130 as described with reference to FIG. 11. Additionally or alternatively, means for performing 1610 may, but not necessarily, include, for example, network communications manager 1210, transceiver 1215, communications manager 1220, antenna 1225, memory 1230, code 1235, processor 1240, inter-station communications manager 1245, and/or bus 1250.

At 1615, the method may include communicating, from at least one of the first transmission reception point or the second transmission reception point, with the UE according to the one or more transmission configuration indicators based on transmitting the single downlink control message. The operations of 1615 may be performed in accordance with examples as disclosed herein. In some examples, aspects of the operations of 1615 may be performed by a communication component 1135 as described with reference to FIG. 11. Additionally or alternatively, means for performing 1615 may, but not necessarily, include, for example, network communications manager 1210, transceiver 1215, communications manager 1220, antenna 1225, memory 1230, code 1235, processor 1240, inter-station communications manager 1245, and/or bus 1250.

The following provides an overview of aspects of the present disclosure:

Aspect 1: A method for wireless communication at a UE, comprising: receiving signaling identifying a configuration for the UE to communicate with a first transmission reception point and a second transmission reception point; receiving downlink control information that comprises one or more transmission configuration indicators, the one or more transmission configuration indicators indicating a first transmission configuration indicator state for the first transmission reception point and a second transmission configuration indicator state for the second transmission reception point; communicating with at least one of the first transmission reception point or the second transmission reception point according to the one or more transmission configuration indicators based at least in part on receiving the downlink control information.

Aspect 2: The method of aspect 1, wherein receiving the downlink control information that comprises the one or more transmission configuration indicators comprises: receiving the downlink control information comprising a first codepoint in a first field of the downlink control information and a second codepoint in a second field of the downlink control information, wherein the first codepoint indicates the first transmission configuration indicator state and the second codepoint indicates the second transmission configuration indicator state.

Aspect 3: The method of aspect 2, wherein each of the first field and the second field indicates a respective joint transmission configuration indicator state, a downlink transmission configuration indicator state, an uplink transmission configuration indicator state, or any combination thereof.

Aspect 4: The method of any of aspects 2 through 3, wherein one of the first transmission configuration indicator state or the second transmission configuration indicator state is associated with a null transmission configuration indicator state for one of the first transmission reception point or the second transmission reception point, and wherein the communicating comprises: communicating with the other of the first transmission reception point or the second transmission reception point.

Aspect 5: The method of any of aspects 1 through 4, wherein receiving the downlink control information that comprises the one or more transmission configuration indicators comprises: receiving the downlink control information comprising a codepoint in a field of the downlink control information, wherein the codepoint indicates the first transmission configuration indicator state and the second transmission configuration indicator state.

Aspect 6: The method of aspect 5, wherein the field indicates two joint transmission configuration indicator states, two downlink transmission configuration indicator states, two uplink configuration indicator states, or any combination thereof.

Aspect 7: The method of any of aspects 1 through 6, further comprising: receiving a first medium access control (MAC) control element (MAC-CE) transmission indicating to activate the first transmission configuration indicator state for the first transmission reception point, wherein communicating with the first transmission reception point is based at least in part on receiving the first MAC-CE transmission; and receiving a second MAC-CE transmission indicating to activate the second transmission configuration indicator state for the second transmission reception point, wherein communicating with the second transmission reception point is based at least in part on receiving the second MAC-CE transmission.

Aspect 8: The method of any of aspects 1 through 7, further comprising: receiving a medium access control (MAC) control element (MAC-CE) transmission indicating to activate the first transmission configuration indicator state for the first transmission reception point and the second transmission configuration indicator state for the second transmission reception point, wherein communicating with the first transmission reception point and the second transmission reception point is based at least in part on receiving the MAC-CE transmission.

Aspect 9: The method of any of aspects 1 through 8, further comprising: receiving radio resource control signaling or medium access control (MAC) control element signaling indicating a respective set of channels, a respective set of reference signals, or both for each of the first transmission indicator state and the second transmission indicator state.

Aspect 10: The method of any of aspects 1 through 9, wherein the one or more transmission configuration indicators comprise a single transmission configuration indicator, and wherein the single transmission configuration indicator is associated with a plurality of reference signals, the method further comprising: determining a first set of spatial parameters, a first spatial transmit filter, or both, for the first transmission reception point based at least in part on a first of the plurality of reference signals and a second set of spatial parameters, a second spatial transmit filter, or both, for the second transmission reception point based at least in part on a second of the plurality of reference signals.

Aspect 11: The method of any of aspects 1 through 10, further comprising: determining a first reference signal associated with the first transmission configuration indicator state based at least in part on a first transmission reception point identifier associated with the first reference signal and a second reference signal associated with the second transmission configuration indicator state based at least in part on a second transmission reception point identifier associated with the second reference signal.

Aspect 12: The method of aspect 11, wherein the first transmission reception point identifier and the second transmission reception point identifier each comprise a control resource set pool identifier, a sounding reference signal resource set identifier, a close-loop index identifier, or any combination thereof.

Aspect 13: A method for wireless communication at a network, comprising: transmitting, to a UE, signaling identifying a configuration for the UE to communicate with a first transmission reception point and a second transmission reception point of the network; transmitting, to the UE, downlink control information that comprises one or more transmission configuration indicators, the one or more transmission configuration indicators indicating a first transmission configuration indicator state for the first transmission reception point and a second first transmission configuration indicator state for the second transmission reception point communicating, from at least one of the first transmission reception point or the second transmission reception point, with the UE according to the one or more transmission configuration indicators based at least in part on transmitting the downlink control information.

Aspect 14: The method of aspect 13, wherein transmitting the downlink control information that comprises the one or more transmission configuration indicators comprises: transmitting, to the UE, the downlink control information comprising a first codepoint in a first field of the downlink control information and a second codepoint in a second field of the downlink control information, wherein the first codepoint indicates the first transmission configuration indicator state and the second codepoint indicates the second transmission configuration indicator state.

Aspect 15: The method of aspect 14, wherein each of the first field and the second field indicates a respective joint transmission configuration indicator state, a downlink transmission configuration indicator state, an uplink configuration indicator state, or any combination thereof.

Aspect 16: The method of any of aspects 13 through 15, wherein one of the first transmission configuration indicator state or the second transmission configuration indicator state is associated with a null transmission configuration indicator state for one of the first transmission reception point or the second transmission reception point, and wherein the communicating comprises: communicating with the UE from the other of the first transmission reception point or the second transmission reception point.

Aspect 17: The method of any of aspects 13 through 16, wherein transmitting the downlink control information that comprises the one or more transmission configuration indicators comprises: transmitting, to the UE, downlink control information comprising a codepoint in a field of the downlink control information, wherein the codepoint indicates the first transmission configuration indicator state and the second transmission configuration indicator state.

Aspect 18: The method of aspect 17, wherein the field indicates two joint transmission configuration indicator states, two downlink transmission configuration indicator states, two uplink configuration indicator states, or any combination thereof.

Aspect 19: The method of any of aspects 13 through 18, further comprising: transmitting a first medium access control (MAC) control element (MAC-CE) transmission indicating to activate the first transmission configuration indicator state for the first transmission reception point, wherein communicating from the first transmission reception point with the UE is based at least in part on transmitting the first MAC-CE transmission; and transmitting a second MAC-CE transmission indicating to activate the second transmission configuration indicator state for the second transmission reception point, wherein communicating from the second transmission reception point with the UE is based at least in part on transmitting the second MAC-CE transmission.

Aspect 20: The method of any of aspects 13 through 19, further comprising: transmitting a medium access control (MAC) control element (MAC-CE) transmission indicating to activate the first transmission configuration indicator state for the first transmission reception point and the second transmission configuration indicator state for the second transmission reception point, wherein communicating from the first transmission reception point and the second transmission reception point with the UE is based at least in part on transmitting the MAC-CE transmission.

Aspect 21: The method of any of aspects 13 through 20, further comprising: transmitting radio resource control signaling or medium access control (MAC) control element signaling indicating a respective set of channels, a respective set of reference signals, or both for each of the first transmission indicator state.

Aspect 22: An apparatus for wireless communication at a UE, comprising a processor; memory coupled with the processor; and instructions stored in the memory and executable by the processor to cause the apparatus to perform a method of any of aspects 1 through 12.

Aspect 23: An apparatus for wireless communication at a UE, comprising at least one means for performing a method of any of aspects 1 through 12.

Aspect 24: A non-transitory computer-readable medium storing code for wireless communication at a UE, the code comprising instructions executable by a processor to perform a method of any of aspects 1 through 12.

Aspect 25: An apparatus for wireless communication at a network, comprising a processor; memory coupled with the processor; and instructions stored in the memory and executable by the processor to cause the apparatus to perform a method of any of aspects 13 through 21.

Aspect 26: An apparatus for wireless communication at a network, comprising at least one means for performing a method of any of aspects 13 through 21.

Aspect 27: A non-transitory computer-readable medium storing code for wireless communication at a network, the code comprising instructions executable by a processor to perform a method of any of aspects 13 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving signaling identifying a configuration for the UE to communicate with a first transmission reception point and a second transmission reception point;
receiving a single downlink control message that comprises one or more transmission configuration indicators, the one or more transmission configuration indicators indicating a first transmission configuration indicator state for the first transmission reception point and a second transmission configuration indicator state for the second transmission reception point; and
communicating with at least one of the first transmission reception point or the second transmission reception point according to the one or more transmission configuration indicators based at least in part on receiving the single downlink control message.

2. The method of claim 1, wherein receiving the single downlink control message that comprises the one or more transmission configuration indicators comprises:
receiving the single downlink control message comprising a first codepoint in a first field of the single downlink control message and a second codepoint in a second field of the single downlink control message, wherein the first codepoint indicates the first transmission configuration indicator state and the second codepoint indicates the second transmission configuration indicator state.

3. The method of claim 2, wherein each of the first field and the second field indicates a respective joint transmission configuration indicator state, a downlink transmission configuration indicator state, an uplink transmission configuration indicator state, or any combination thereof.

4. The method of claim 2, wherein one of the first transmission configuration indicator state or the second transmission configuration indicator state is associated with a null transmission configuration indicator state for one of the first transmission reception point or the second transmission reception point, and wherein the communicating comprises:
communicating with the other of the first transmission reception point or the second transmission reception point.

5. The method of claim 1, wherein receiving the single downlink control message that comprises the one or more transmission configuration indicators comprises:
receiving the single downlink control message comprising a codepoint in a field of the single downlink control message, wherein the codepoint indicates the first transmission configuration indicator state and the second transmission configuration indicator state.

6. The method of claim 5, wherein the field indicates two joint transmission configuration indicator states, two downlink transmission configuration indicator states, two uplink configuration indicator states, or any combination thereof.

7. The method of claim 1, further comprising:
receiving a first medium access control (MAC) control element (MAC-CE) transmission indicating to activate the first transmission configuration indicator state for the first transmission reception point, wherein communicating with the first transmission reception point is based at least in part on receiving the first MAC-CE transmission; and
receiving a second MAC-CE transmission indicating to activate the second transmission configuration indicator state for the second transmission reception point, wherein communicating with the second transmission reception point is based at least in part on receiving the second MAC-CE transmission.

8. The method of claim 1, further comprising:
receiving a single medium access control (MAC) control element (MAC-CE) transmission indicating to activate the first transmission configuration indicator state for the first transmission reception point and the second transmission configuration indicator state for the second transmission reception point, wherein communicating with the first transmission reception point and the second transmission reception point is based at least in part on receiving the MAC-CE transmission.

9. The method of claim 1, further comprising:
receiving radio resource control signaling or medium access control (MAC) control element signaling indicating a respective set of channels, a respective set of reference signals, or both for each of the first transmission configuration indicator state and the second transmission configuration indicator state.

10. The method of claim 1, wherein the one or more transmission configuration indicators comprise a single transmission configuration indicator, and wherein the single transmission configuration indicator is associated with a plurality of reference signals, the method further comprising:
determining a first set of spatial parameters, a first spatial transmit filter, or both, for the first transmission reception point based at least in part on a first of the plurality of reference signals and a second set of spatial parameters, a second spatial transmit filter, or both, for the second transmission reception point based at least in part on a second of the plurality of reference signals.

11. The method of claim 1, further comprising:
determining a first reference signal associated with the first transmission configuration indicator state based at least in part on a first transmission reception point identifier associated with the first reference signal and a second reference signal associated with the second transmission configuration indicator state based at least in part on a second transmission reception point identifier associated with the second reference signal.

12. The method of claim 11, wherein the first transmission reception point identifier and the second transmission reception point identifier each comprise a control resource set pool identifier, a sounding reference signal resource set identifier, a close-loop index identifier, or any combination thereof.

13. A method for wireless communication at a network, comprising:
transmitting, to a user equipment (UE), signaling identifying a configuration for the UE to communicate with a first transmission reception point and a second transmission reception point of the network;
transmitting, to the UE, a single downlink control message that comprises one or more transmission configuration indicators, the one or more transmission configuration indicators indicating a first transmission configuration indicator state for the first transmission reception point and a second transmission configuration indicator state for the second transmission reception point; and
communicating, from at least one of the first transmission reception point or the second transmission reception point, with the UE according to the one or more transmission configuration indicators based at least in part on transmitting the single downlink control message.

14. The method of claim 13, wherein transmitting the single downlink control message that comprises the one or more transmission configuration indicators comprises:
transmitting, to the UE, the single downlink control message comprising a first codepoint in a first field of the single downlink control message and a second codepoint in a second field of the single downlink control message, wherein the first codepoint indicates the first transmission configuration indicator state and the second codepoint indicates the second transmission configuration indicator state.

15. The method of claim 14, wherein each of the first field and the second field indicates a respective joint transmission configuration indicator state, a downlink transmission configuration indicator state, an uplink configuration indicator state, or any combination thereof.

16. The method of claim 13, wherein one of the first transmission configuration indicator state or the second transmission configuration indicator state is associated with a null transmission configuration indicator state for one of the first transmission reception point or the second transmission reception point, and wherein the communicating comprises:
communicating with the UE from the other of the first transmission reception point or the second transmission reception point.

17. The method of claim 13, wherein transmitting the single downlink control message that comprises the one or more transmission configuration indicators comprises:
transmitting, to the UE, the single downlink control message comprising a codepoint in a field of the single downlink control message, wherein the codepoint indicates the first transmission configuration indicator state and the second transmission configuration indicator state.

18. The method of claim 17, wherein the field indicates two joint transmission configuration indicator states, two downlink transmission configuration indicator states, two uplink configuration indicator states, or any combination thereof.

19. The method of claim 13, further comprising:
transmitting a first medium access control (MAC) control element (MAC-CE) transmission indicating to activate the first transmission configuration indicator state for the first transmission reception point, wherein communicating from the first transmission reception point with the UE is based at least in part on transmitting the first MAC-CE transmission; and
transmitting a second MAC-CE transmission indicating to activate the second transmission configuration indicator state for the second transmission reception point, wherein communicating from the second transmission reception point with the UE is based at least in part on transmitting the second MAC-CE transmission.

20. The method of claim 13, further comprising:
transmitting a medium access control (MAC) control element (MAC-CE) transmission indicating to activate the first transmission configuration indicator state for the first transmission reception point and the second transmission configuration indicator state for the second transmission reception point, wherein communicating from the first transmission reception point and the second transmission reception point with the UE is based at least in part on transmitting the MAC-CE transmission.

21. The method of claim 13, further comprising:
transmitting radio resource control signaling or medium access control (MAC) control element signaling indicating a respective set of channels, a respective set of reference signals, or both for each of the first transmission configuration indicator state.

22. An apparatus for wireless communication, comprising:
memory;
a transceiver; and
at least one processor of a user equipment (UE), the at least one processor coupled with the memory and the transceiver, and the at least one processor configured to cause the apparatus to:
receive, via the transceiver, signaling identifying a configuration for the UE to communicate with a first transmission reception point and a second transmission reception point;
receive, via the transceiver, a single downlink control message that comprises one or more transmission configuration indicators, the one or more transmission configuration indicators indicating a first transmission configuration indicator state for the first transmission reception point and a second transmission configuration indicator state for the second transmission reception point; and
communicate, via the transceiver, with at least one of the first transmission reception point or the second transmission reception point according to the one or more transmission configuration indicators based at least in part on receiving the single downlink control message.

23. The apparatus of claim 22, wherein the at least one processor being configured to cause the apparatus to receive the single downlink control message that comprises the one or more transmission configuration indicators comprises the at least one processor being configured to cause the apparatus to:
receive, via the transceiver, the single downlink control message comprising a first codepoint in a first field of the single downlink control message and a second codepoint in a second field of the single downlink control message, wherein the first codepoint indicates the first transmission configuration indicator state and the second codepoint indicates the second transmission configuration indicator state.

24. The apparatus of claim 23, wherein each of the first field and the second field indicates a respective joint transmission configuration indicator state, a downlink transmission configuration indicator state, an uplink transmission configuration indicator state, or any combination thereof.

25. The apparatus of claim 23, wherein the at least one processor being configured to cause the apparatus to communicate comprises the at least one processor being configured to cause the apparatus to:
communicate, via the transceiver, with the other of the first transmission reception point or the second transmission reception point.

26. The apparatus of claim 22, wherein the at least one processor being configured to cause the apparatus to receive the single downlink control message that comprises the one or more transmission configuration indicators comprises the at least one processor being configured to cause the apparatus to:
receive, via the transceiver, the single downlink control message comprising a codepoint in a field of the single downlink control message, wherein the codepoint indicates the first transmission configuration indicator state and the second transmission configuration indicator state.

27. The apparatus of claim 26, wherein the field indicates two joint transmission configuration indicator states, two downlink transmission configuration indicator states, two uplink configuration indicator states, or any combination thereof.

28. The apparatus of claim 22, wherein the at least one processor is further configured to cause the apparatus to:
receive, via the transceiver, a first medium access control (MAC) control element (MAC-CE) transmission indicating to activate the first transmission configuration indicator state for the first transmission reception point, wherein communicating with the first transmission reception point is based at least in part on receiving the first MAC-CE transmission; and
receive, via the transceiver, a second MAC-CE transmission indicating to activate the second transmission configuration indicator state for the second transmission reception point, wherein communicating with the second transmission reception point is based at least in part on receiving the second MAC-CE transmission.

29. The apparatus of claim 22, wherein the at least one processor is further configured to cause the apparatus to:
receive, via the transceiver, a medium access control (MAC) control element (MAC-CE) transmission indicating to activate the first transmission configuration indicator state for the first transmission reception point and the second transmission configuration indicator state for the second transmission reception point, wherein communicating with the first transmission reception point and the second transmission reception point is based at least in part on receiving the MAC-CE transmission.

30. An apparatus for wireless communication, comprising:
memory;
a transceiver; and
at least one processor of a network entity of a network, the at least one processor coupled with the memory and the transceiver, and the at least one processor configured to cause the apparatus to:
transmit, to a user equipment (UE) via the transceiver, signaling identifying a configuration for the UE to communicate with a first transmission reception point and a second transmission reception point of the network;
transmit, to the UE via the transceiver, a single downlink control message that comprises one or more transmission configuration indicators, the one or more transmission configuration indicators indicating a first transmission configuration indicator state for the first transmission reception point and a second transmission configuration indicator state for the second transmission reception point; and
communicate, from at least one of the first transmission reception point or the second transmission reception point, with the UE according to the one or more transmission configuration indicators based at least in part on transmitting the single downlink control message.
